(19) United States
(12) Patent Application Publication
(10) Pub. No.: US 2026/0357435 A1
(43) Pub. Date: Nov. 12, 2026

(54) METHOD FOR MANUFACTURING ELECTROPHOTOGRAPHIC PHOTORECEPTOR

(71) Applicant: KYOCERA DOCUMENT SOLUTIONS INC., Osaka (JP)

(72) Inventor: YUICHI YOSHIDA, Osaka (JP)

(21) Appl. No.: 19/636,876

(22) Filed: Apr. 1, 2026

(30) Foreign Application Priority Data
Apr. 23, 2025 (JP) 2025-071879

(51) Int. Cl. C23C 22/66; G03G 5/10; G03G 5/14

(52) U.S. Cl. CPC C23C 22/66; G03G 5/102; G03G 5/144

(57) ABSTRACT

An electrophotographic photoreceptor manufactured by a method is a negatively charged electrophotographic photoreceptor including a conductive base and a photosensitive layer held on the conductive base. The method for manufacturing the electrophotographic photoreceptor includes immersing the conductive base containing aluminum or an aluminum alloy in alkaline ionized water having a pH of 10.0 or more and a temperature of 35 °C or more for 35 seconds or more.

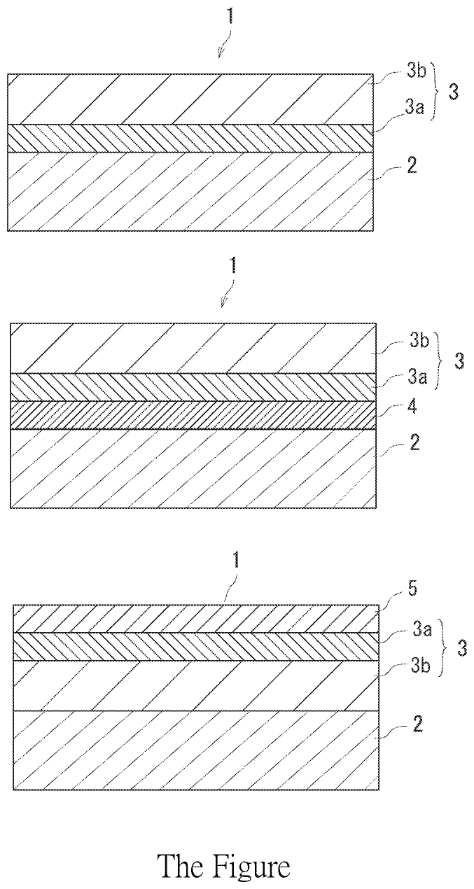

### CROSS-REFERENCE TO RELATED PATENT APPLICATION

This application claims the benefit of Japanese Priority Patent Application JP 2025-071879 filed on Apr. 23, 2025, the entire contents of which are incorporated herein by reference.

### FIELD OF THE DISCLOSURE

The present disclosure relates to a method for manufacturing a negatively charged electrophotographic photoreceptor.

### BACKGROUND OF THE DISCLOSURE

An electrophotographic photoreceptor is used as an image carrier in an electrophotographic image forming apparatus (e.g., a printer or multifunction device). When forming an image on a recording medium using the image forming apparatus, steps such as charging, exposure, development, transfer, and fixing are repeatedly performed. During the transfer steps, a transfer bias of opposite polarity to a charging polarity is applied to the electrophotographic photoreceptor to transfer a toner image adhering to the surface of the electrophotographic photoreceptor onto the recording medium. At this time, a residual charge of opposite polarity caused by the transfer bias may remain in a photoconductive layer of the electrophotographic photoreceptor. This residual charge can alter electrical characteristics of the electrophotographic photoreceptor, potentially causing an image defect.

To counter this, an electricity removal device is provided in the image forming apparatus to remove the residual charge from the electrophotographic photoreceptor, thereby suppressing an occurrence of the image defect. However, in recent years, demand has increased for the image forming apparatus without the electricity removal device, from the perspective of space savings and lower cost. Consequently, there is a need for an electrophotographic photoreceptor with transfer resistance, which is less susceptible to an effect of the transfer bias, for the image forming apparatus without the electricity removal device.

### SUMMARY OF THE DISCLOSURE

According to an embodiment of the present disclosure, a method for manufacturing an electrophotographic photoreceptor is a method for manufacturing a negatively charged electrophotographic photoreceptor including a conductive base and a photosensitive layer held on the conductive base.

In the method for manufacturing the electrophotographic photoreceptor, the conductive base containing aluminum or an aluminum alloy is immersed in alkaline ionized water having a pH of 10.0 or more and a temperature of 35 °C or more for 35 seconds or more.

### BRIEF DESCRIPTION OF THE DRAWINGS

The FIGURE is partial cross-sectional views (A) to (C) each showing an example of an electrophotographic photoreceptor manufactured by a manufacturing method according to an embodiment of the present disclosure.

### DETAILED DESCRIPTION OF THE EXEMPLARY EMBODIMENTS

The embodiments of the present disclosure will now be described in detail. However, the present disclosure is not limited to the embodiments described below. The present disclosure may be implemented with appropriate modifications within the scope of the objectives of the present disclosure. Furthermore, where descriptions overlap, explanations may be omitted as appropriate, but the essence of the invention is not limited thereby.

### <Method for Manufacturing an Electrophotographic Photoreceptor>

### [Electrophotographic Photoreceptor]

The electrophotographic photoreceptor manufactured by the method of this embodiment is a negatively charged electrophotographic photoreceptor including a conductive base and a photosensitive layer held on the conductive base.

Referring to (A) to (C) of The FIGURE, the electrophotographic photoreceptor (hereinafter sometimes referred to as the photoreceptor) manufactured by the method for manufacturing the electrophotographic photoreceptor according to the present embodiment will be described. (A) to (C) of The FIGURE are schematic cross-sectional views showing a structure of the photoreceptor 1. The photoreceptor 1 includes a conductive base 2 and a photosensitive layer 3, and has a charging polarity being a negative charge polarity. The photoreceptor 1 is typically a functionally separated type photoreceptor, where functions of charge generation and charge transport are separated. The photosensitive layer 3 includes a charge generation layer 3a and a charge transport layer 3b. The photosensitive layer 3 is provided directly or indirectly on the conductive base 2. For example, as shown in (A) of The FIGURE, the photosensitive layer 3 may be provided directly on the conductive base 2. Alternatively, as shown in (B) of The FIGURE, an intermediate layer 4 may be provided between the conductive base 2 and the photosensitive layer 3. Furthermore, as shown in (A) and (B) of The FIGURE, the photosensitive layer 3 may be exposed as an outermost layer. As shown in (C) of The FIGURE, a protective layer 5 may be provided on the photosensitive layer 3. Furthermore, as shown in (C) of The FIGURE, a charge transport layer 3b may be formed on the base 2, with the charge generation layer 3a formed thereon. Alternatively, as shown in (A) and (B) of The FIGURE, the charge transport layer 3b may be formed on the charge generation layer 3a, with the protective layer 5 further formed thereon. In the photosensitive layer 3, the charge transport layer 3b is preferably formed on the charge generation layer 3a.

The conductive base 2 contains aluminum or an aluminum alloy. The inclusion of aluminum or an aluminum alloy in the conductive base tends to improve a charge transfer from the photosensitive layer to the conductive base in the manufactured photoreceptor 1. The aluminum alloy is an alloy of aluminum and elements other than aluminum. Examples of the elements other than aluminum include manganese (Mn), silicon (Si), magnesium (Mg), copper (Cu), iron (Fe), chromium (Cr), titanium (Ti), or zinc (Zn). The aluminum alloy may contain one of these elements alone or two or more of them. Examples of the aluminum alloys include Al—Mn based alloys (JIS 3000 series), Al—Mg based alloys (JIS 5000 series), or Al—Mg—Si based alloys (JIS 6000 series).

The shape of the conductive base is selected appropriately according to the structure of an image forming apparatus. Examples of the shape of the conductive base include sheet-shaped or drum-shaped. Furthermore, the thickness of the conductive base is selected appropriately according to the shape of the conductive base.

In the method for manufacturing the electrophotographic photoreceptor according to this embodiment, a specific treatment is performed on the conductive base 2 prior to a step of forming the photosensitive layer 3 or the intermediate layer 4 on the conductive base 2. As will be described in detail later, this stabilizes a surface state of the conductive base 2, making it difficult for a residual charge to become trapped within the photoreceptor 1. This suppresses the accumulation of the residual charge, resulting in the photoreceptor 1 possessing transfer resistance that is less susceptible to an effect of a transfer bias.

When the photoreceptor 1 is provided as an image carrier in the image forming apparatus, an image is formed on a recording medium as the image carrier rotates. During one rotation of the image carrier, charging, exposure, development, and transfer occur. Repeated use causes the residual charge to accumulate due to the transfer bias. This causes changes in electrical characteristics of the photoreceptor 1, leading to reduced transfer efficiency and image defect. However, with the electrophotographic photoreceptor manufactured by the method according to this embodiment, the residual charge accumulates less readily after a transfer even with the repeated use. This maintains a uniform surface potential of the photoreceptor 1, enabling sustained high transfer efficiency. Furthermore, preventing an increase in the surface potential after the transfer caused by the residual charge, which suppresses an occurrence of a ghost image. Here, the ghost image refers to the image defect where an image pattern from a previous rotation faintly appears on the surface of the photoreceptor 1 during the exposure on the next rotation because the potential does not fully decrease due to the residual potential from the previous rotation. Hereafter, this image defect is also referred to as a ghost image based on a transfer memory. The image forming apparatus including the photoreceptor 1 possessing such transfer resistance eliminates the need for an electricity removal device, enabling formation of high-quality images at low cost.

The following describes treatment steps of this embodiment.

### [Treatment Steps for the Conductive Base]

(Treatment with Alkaline Ionized Water)

In the method for manufacturing the electrophotographic photoreceptor according to this embodiment, the conductive base containing aluminum or the aluminum alloy is immersed in alkaline ionized water having a pH of 10.0 or more and a temperature of 35 °C or more for 35 seconds or more. This step is hereinafter also referred to simply as “alkaline ionized water treatment.”

The alkaline ionized water treatment effectively removes surface contaminants and oil and fat components without roughening the conductive base through corrosion. Furthermore, a film derived from OH ions in the alkaline ionized water is formed on the surface of the conductive base, rendering it hydrophilic. This enhances adhesion to the photosensitive layer and the intermediate layer while suppressing reattachment of the contaminants. Furthermore, enhanced bonding between the conductive base and the layer formed on its surface reduces voids generated between the conductive base and the layer on the surface, which are a cause of charge trapping. This results in an overall decrease in electrical resistance of the conductive base. The easier flow of current within or on the surface of the conductive base effectively suppresses accumulation of the residual charge caused by the transfer bias. Typically, the conductive base can enhance adhesion to the photosensitive layer by roughening or hydrophilizing the surface under harsh treatment conditions, such as etching treatment with an acid having a pH of 7.0 or lower. In contrast, according to the present disclosure, the adhesion to the photosensitive layer (intermediate layer) can be enhanced by hydrophilizing the surface without roughening it under mild treatment conditions using the alkaline ionized water with a pH of 10.0 or more.

Note that the term “alkaline ionized water” as used in this disclosure refers to alkaline water produced at a cathode during electrolysis of water, and is distinguished from an alkaline aqueous solution obtained by adding an alkali such as NaOH or ammonia.

A pH of the alkaline ionized water is not particularly limited as long as it is 10 or more. However, from the perspectives of higher cleaning efficacy and manufacturing cost, a pH of 10 or more and 13 or lower is preferred, and particularly, a pH of 10 or more and 12 or lower is more preferred. As the alkaline ionized water, it is acceptable to use the water on a cathode side when the pH reaches between 10 and 12 while monitoring the pH during the electrolysis. Alternatively, the electrolysis may be performed until the pH reaches 12 or more, and this alkaline ionized water may be diluted with neutral water to adjust the pH to the range of 10 to 12.

From the perspective of shortening the manufacturing step, an immersion time is preferably 35 seconds or more and within 90 seconds, more preferably 35 seconds or more and within 80 seconds, and most preferably 35 seconds or more and within 70 seconds.

The immersion time of the conductive base in the alkaline ionized water and the pH of the alkaline ionized water are preferably one of the combination examples S1 to S2 shown in Table 1. This combination allows for a greater reduction in the surface potential after the transfer.

TABLE 1

| Combination | Alkali ionized water treatment | | |
|---|---|---|---|
| example | pH | Temperature(°C) | Time(sec) |
| S 1 | 10 or more and | 45 or more and | 35 or more and |
| | less than 11 | 60 or less | 40 or less |
| S 2 | 11 or more and | 55 or more and | 35 or more and |
| | less than 12 | 60 or less | 40 or less |

### (Pure Water Treatment)

After the alkaline ionized water immersion step, the conductive base may be immersed in pure water for 30 seconds or more. This provides improved transfer resistance. This step is hereinafter also referred to simply as “pure water treatment.” This pure water treatment removes excess alkaline ionized water adhering to the surface. At this time, the surface of the conductive base is hydrated by the pure water, making the film derived from the OH ions formed during the alkaline ionized water treatment more resistant to peeling. It is thought to more stabilize a surface condition of the conductive base.

From the perspective of shortening the manufacturing step, the immersion time in pure water is preferably 30 seconds or more and 70 seconds or less, more preferably 30 seconds or more and 60 seconds or less, and most preferably 30 seconds or more and 50 seconds or less.

For the pure water treatment, it is preferable to immerse the conductive base in pure water at 60 °C or more for 30 seconds or more. By maintaining a pure water temperature at 60 °C or more, the excess alkaline ionized water can be efficiently removed in a short time.

From the perspective of not only for reducing the manufacturing costs but also for more readily stabilizing the surface condition of the conductive base, the pure water temperature is preferably 60 °C or more and 90 °C or less, more preferably 60 °C or more and 85 °C or less, and particularly preferably 60 °C or more and 80 °C or less.

The immersion time and the pure water temperature described above enable more effective removal of the excess alkaline ionized water adhering after the alkaline ionized water treatment step. After a conventional degreasing step, rinsing steps such as ultrasonic rinsing using an ultrasonic transducer, bubbling rinsing using bubbles, or rinsing by shaking the conductive base vertically are typically required to remove a cleaning solution adhering to the surface of the conductive base. However, the cleaning solution can be efficiently removed through a simple step of merely immersing in pure water and allowing it to stand. Furthermore, cleaning with pure water reduces environmental impacts.

Furthermore, in the rinsing step after the conventional degreasing, it has been believed that the higher the temperature of the pure water and the longer the immersion time, the more the surface condition of the surface of the base would change, potentially affecting electrical properties of the photosensitive layer. Consequently, the rinsing step is typically performed for a short duration, such as within 5 seconds, using room temperature water or cold water. In contrast, the pure water treatment after the alkaline ionized water treatment according to this embodiment enables achievement of a favorable surface condition on the conductive base and imparts excellent transfer resistance, even with a relatively long immersion time and a relatively high temperature.

### (Other Steps)

After the treatment described above, the conductive base is removed from the pure water and may be dried to an extent that does not alter surface properties of the base; air drying is preferred. Furthermore, from the perspective of not altering the surface properties of the base, it is preferable to avoid an acid etching treatment, etc.

### [Formation Step of the Photosensitive Layer]

After the treatment step for the conductive base described above, a photosensitive layer formation step can be performed. For example, a charge generation layer coating solution and then a charge transport layer coating solution are applied onto the treated conductive base to form a photosensitive layer having the charge generation layer and the charge transport layer. An intermediate layer coating solution (undercoat layer coating solution) may be applied onto the conductive base, and the protective layer may be formed on the charge transport layer.

As described above, treating the conductive base with the alkaline ionized water stabilizes the surface condition of the conductive base. Retaining the photosensitive layer on this stabilized surface reduces the trapping of the residual charge within the photoreceptor, thereby suppressing the accumulation of the residual charge. Specifically, the treatment with the alkaline ionized water efficiently removes the contaminants such as oil and fat components and foreign matters adhering to the surface without altering the surface properties of the conductive base. Furthermore, the film derived from the alkaline ionized water (OH ions) is formed on the surface of the conductive base, imparting hydrophilicity. This improves the adhesion between the film and the surface of the conductive base. Moreover, enhancing the bonding between the conductive base and its surface layer reduces the voids generated between the conductive base and the layer on the surface, which are the cause of the charge trapping. This results in an overall reduction in the electrical resistance of the conductive base. The easier flow of current within or on the surface of the conductive base effectively suppresses the accumulation of the residual charge. Consequently, an electrophotographic photoreceptor with excellent transfer resistance, less susceptible to the effect of the transfer bias, is obtained.

In general, it is known that transfer properties can be improved in the manufacturing method of positively charged electrophotographic photoreceptor by applying specific treatments to a conductive base. However, for negatively charged electrophotographic photoreceptor, sufficient resistance to the transfer properties has not been achieved. To overcome this, the present disclosure is made in light of the above problem, and an object is to provide a method for manufacturing a negatively charged electrophotographic photoreceptor having resistance to transfer properties that is less susceptible to an effect of a transfer bias.

### EXAMPLES

The present disclosure will now be described in more detail using examples. However, the present disclosure is not limited to the scope of the examples.

### [1. Photoreceptor Materials]

A hole transport agent (HTM-1), an electron acceptor compound (EA-1), and a binder resin (R-1) were prepared as materials for forming the photosensitive layer of the photoreceptor.

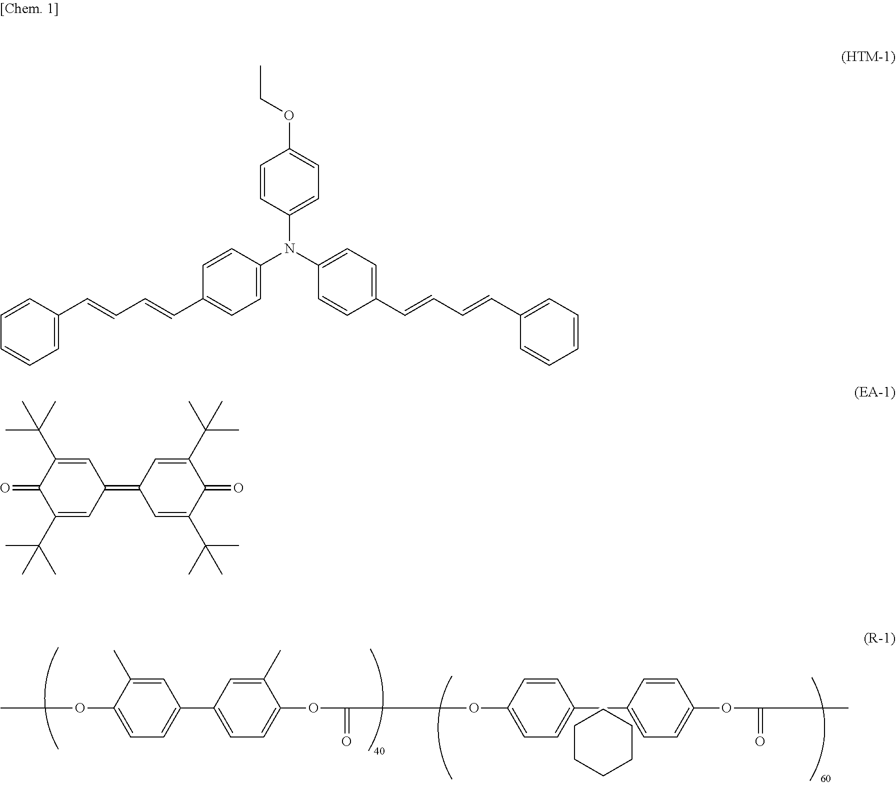

### [2. Manufacturing of the Photoreceptor]

Using the prepared materials for forming the photosensitive layer of the photoreceptor, photoreceptors (A-1) to (A-11) and photoreceptors (B-1) to (B-5) were manufactured by the following method.

### Manufacture of the Photoreceptor (A-1)

### (Treatment of the Conductive Base)

A cylindrical conductive base made of aluminum, measuring 30 mm in diameter, 245 mm in length, and 1 mm in thickness, was prepared. First, it was treated with the alkaline ionized water. Specifically, strongly alkaline ionized water generated by the EW-01-RO21 alkaline ionized water generator manufactured by Nisshin Seiki Co., Ltd. was diluted with pure water to obtain the alkaline ionized water with a pH of 10.0. This alkaline ionized water was placed in a tank with a depth of 500 mm and heated to 35 °C using a heater. Next, the entire conductive base was immersed therein for 35 seconds to perform the alkaline ionized water treatment. Second, a pure water treatment was performed. Specifically, the pure water was poured into a tank with a depth of 500 mm and heated to 60 °C using a heater. Subsequently, the entire conductive base was immersed therein for 30 seconds to perform the pure water treatment. Afterwards, the conductive base was air-dried, completing the treatment of the conductive base and yielding the treated conductive base.

### (Preparation of the Intermediate Layer Coating Solution)

Methanol, n-butanol, and toluene were mixed to obtain solvent A (mass ratio: methanol/n-butanol/toluene=3/1/1). One part by mass of polyamide resin (“Amilan (registered trademark) CM8000” manufactured by Toray Industries, Inc., a quaternary copolymer polyamide resin of polyamide 6, polyamide 12, polyamide 66, and polyamide 610) was dissolved in 4 parts by mass of the solvent A to obtain Resin Solution B. 2.0 parts by mass of titanium oxide (prototype “SMT-A” manufactured by Teika Co., Ltd., having a number-average particle size of 10 nm, in which titanium oxide is primary surface-treated with alumina and silica, then primary surface-treated titanium oxide is secondary surface-treated with methyl hydrogen polysiloxane) and 0.5 parts by mass of ion-exchanged water, 5.0 parts by mass of resin solution B, and 8.0 parts by mass of the solvent A were mixed for 6 hours at a peripheral speed of 8 m/s using a circulating wet disperser (“DYNO (registered trademark) MILL” manufactured by Willy & Backofen Co., Ltd.) to obtain an intermediate layer coating solution.

### (Formation of the Intermediate Layer)

The obtained intermediate layer coating solution was filtered using a 30 μm mesh filter. Subsequently, the intermediate layer coating solution was applied to the surface of the treated conductive base using the dip-coating method. An aluminum drum-shaped support (diameter: 30 mm, length: 245.0 mm) was used as the conductive base. Subsequently, the applied intermediate layer coating solution was heat-treated at 120 °C for 20 minutes to form an intermediate layer (film thickness: 0.7 μm) on the conductive base.

### (Preparation of the Charge Generation Layer Solution)

Propylene glycol monomethyl ether and tetrahydrofuran were mixed to obtain solvent C (mass ratio: propylene glycol monomethyl ether/tetrahydrofuran=1/2). 1.0 parts by mass of polyvinyl acetate resin (“S-LEC BX-5” manufactured by Sekisui Chemical Co., Ltd.) was dissolved in 19.0 parts by mass of the solvent C to obtain resin solution D. As a charge generating agent, 2.3 parts by mass of Y-type titanyl phthalocyanine, 20.0 parts by mass of resin solution D (polyvinyl acetate resin content: 1.0 part by mass), and 65.0 parts by mass of the solvent C were mixed using a media disperser (bead mill). The mixing conditions were: peripheral speed of 60 rpm, mixing time of 4 hours, zirconia beads (diameter 0.65 mm) as the media type disperser media, and a media filling rate of the media type disperser of 46.2%. In this manner, a charge generating layer coating solution was obtained.

### (Formation of the Charge Generation Layer)

The obtained charge generation layer coating solution was filtered using a 5 μm mesh filter. The filtered solution was applied onto the intermediate layer by the dip coating and heat treated at 90 °C for 20 minutes. In this manner, a charge generation layer (film thickness: 0.5 μm) was formed on the intermediate layer.

### (Preparation of the Charge Transport Layer Coating Solution)

Toluene and tetrahydrofuran were mixed to obtain solvent E (mass ratio: toluene/tetrahydrofuran=1/9). 61.00 parts by mass of the hole transport agent (HTM-1), 4.00 parts by mass of an antioxidant (butylated hydroxytoluene), 2.00 parts by mass of the electron acceptor compound (EA-1), 0.05 parts by mass of a leveling agent (“KF96-50CS,” dimethyl silicone oil, manufactured by Shin-Etsu Chemical Co., Ltd.), and 100.00 parts by mass of the polycarbonate resin (R-1) as the binder resin were dissolved in 650.00 parts by mass of the solvent E to obtain a charge transport layer coating solution. A viscosity-average molecular weight of the polycarbonate resin (R-1) was 60,000.

### (Formation of the Charge Transport Layer)

Using the dip-coating method, the obtained charge transport layer coating solution was applied onto the charge generation layer. It was then heated from 60 °C to 125 °C at a heating rate of 1 °C/min, followed by a total heat treatment of 60 minutes at 125 °C. In this manner, a charge transport layer (film thickness: 26.0 μm) was formed on the charge generation layer, yielding the photoreceptor (A-1). In the photoreceptor (A-1), the intermediate layer was provided on the conductive base, the charge generation layer was provided on the intermediate layer, and the charge transport layer was provided on the charge generation layer.

### Manufacture of the Photoreceptor (A-2)

The photoreceptor (A-2) was obtained by the same manner in the treatment of the conductive base for the photoreceptor (A-1), except that the temperature of the alkaline ionized water was changed to 45 °C.

### Manufacture of the Photoreceptor (A-3)

The photoreceptor (A-3) was obtained by the same manner in the treatment of the conductive base for the photoreceptor (A-1), except that the temperature of the alkaline ionized water was changed to 55 °C.

### Manufacture of the Photoreceptor (A-4)

The photoreceptor (A-4) was obtained by the same manner in the treatment of the conductive base for the photoreceptor (A-1), except that the strong alkaline ionized water was diluted with pure water to achieve a pH of 11.5.

### Manufacture of the Photoreceptor (A-5)

The photoreceptor (A-5) was obtained by the same manner in the treatment of the conductive base for the photoreceptor (A-4), except that the temperature of the alkaline ionized water was changed to 45 °C.

### Manufacture of the Photoreceptor (A-6)

The photoreceptor (A-6) was obtained by the same manner in the treatment of the conductive base for the photoreceptor (A-4), except that the temperature of the alkaline ionized water in the treatment of the conductive base was changed to 55 °C.

### Manufacture of the Photoreceptor (A-7)

The photoreceptor (A-7) was obtained by the same manner in the treatment of the conductive base for the photoreceptor (A-1), except that the immersion time of the conductive base in the alkaline ionized water was changed to 70 seconds.

### Manufacture of the Photoreceptor (A-8)

The photoreceptor (A-8) was obtained by the same manner in the treatment of the conductive base for the photoreceptor (A-4), except that the immersion time of the conductive base in the alkaline ionized water was changed to 70 seconds.

### Manufacture of the Photoreceptor (A-9)

The photoreceptor (A-9) was obtained by the same manner in the treatment of the conductive base for the photoreceptor (A-1), except that the immersion time of the conductive base in pure water was changed to 50 seconds.

### Manufacture of the Photoreceptor (A-10)

The photoreceptor (A-10) was obtained by the same manner in the treatment of the conductive base for the photoreceptor (A-4), except that the immersion time of the conductive base in pure water was changed to 50 seconds and the temperature of the pure water was changed to 80 °C.

### Manufacture of the Photoreceptor (A-11)

The photoreceptor (A-11) was obtained by the same manner in the treatment of the conductive base for the photoreceptor (A-1), except that the temperature of the pure water used in the treatment of the conductive base was changed to 20 °C.

### Manufacture of the Photoreceptor (B-1)

The photoreceptor (B-1) was obtained by the same manner in the treatment of the conductive base for the photoreceptor (A-1), except that the temperature of the alkaline ionized water was changed to 30 °C.

### Manufacture of the Photoreceptor (B-2)

The photoreceptor (B-2) was obtained by the same manner in the treatment of the conductive base for the photoreceptor (A-4), except that the temperature of the alkaline ionized water was changed to 20 °C.

### Manufacture of the Photoreceptor (B-3)

The photoreceptor (B-3) was obtained by the same manner in the treatment of the conductive base for the photoreceptor (A-1), except that the strong alkaline ionized water was diluted with pure water to achieve a pH of 9.0.

### Manufacture of the Photoreceptor (B-4)

The photoreceptor (B-4) was obtained by the same manner in the treatment of the conductive base for the photoreceptor (A-4), except that the immersion time of the conductive base in the alkaline ionized water was changed to 25 seconds.

### Manufacture of the Photoreceptor (B-5)

The photoreceptor (B-5) was obtained by the same manner in the treatment of the conductive base for the photoreceptor (A-1), except that the conductive base was not treated with the alkaline ionized water.

### [3. Evaluation]

The transfer resistance of each of the photoreceptors (A-1) to (A-11) and (B-1) to (B-5) was evaluated using the following method.

### (Measurement of Surface Potential After Transfer)

The surface potential after the transfer was measured for each manufactured photoreceptor to evaluate their transfer properties. The measured “surface potential after the transfer” refers to the surface potential of an exposed area of the photoreceptor immediately after the toner image on the surface of the photoreceptor is transferred to the recording medium, and before the surface of the photoreceptor is charged during the next rotation.

The potential after the transfer was measured at a temperature of 23 °C and a relative humidity of 50% RH. Using a drum sensitivity tester (manufactured by Gentec Co., Ltd., with no electricity removal device), the photoreceptor was charged at a rotation speed of the photoreceptor of 200 rpm to achieve the surface potential of the photoreceptor of −600 V. Next, monochromatic light (wavelength: 780 nm, exposure amount: 0.35 μJ/cm²) extracted from the light of a halogen lamp using a bandpass filter was irradiated onto the surface of the photoreceptor. After 150 milliseconds, a current of 15 μA was flowed through the photoreceptor using a transfer device. The surface potential of the photoreceptor after 150 milliseconds was measured and designated as the surface potential after the transfer (unit: V). The surface potential after the transfer is shown in Tables 2A-2B. The “surface potential after the transfer” was measured using a surface potential meter (“MODEL 244” manufactured by Monroe Electronics). The surface potential after the transfer was evaluated based on the following criteria.
Excellent: Surface potential after transfer is 50V or less, and transfer properties are superior.
Good: Surface potential after transfer is less than 65V, and transfer properties are excellent.
Poor: Surface potential after transfer is 65V or more, and transfer properties are poor.

### (Ghost Image Evaluation)

The image was evaluated under conditions at a temperature of 23 °C and a relative humidity of 65% RH. A modified multifunction device (“bizhub c4050i” manufactured by Konica Minolta, Inc.) was used as an evaluation machine. This evaluation machine was modified by altering output settings of a transfer device included in the multifunction device. Furthermore, this evaluation machine did not include the electricity removal device. The photoreceptor was mounted on the evaluation machine, an image I was printed onto paper, and an evaluation image was obtained. The image I contained an image area with a thick-lined letter “G” on a white background positioned upstream in the transport direction of the recording medium, and a halftone image area positioned downstream. The halftone image area of the evaluation image was visually inspected to confirm the presence or absence of image defect caused by the transfer memory. The image defect caused by the transfer memory is, for example, an image imperfection where a ghost of the letter “G” appears in the halftone image area. Suppression of the transfer memory (evaluation of ghost image) was judged based on the following criteria. The judgment results are shown in Tables 2A-2B.
A (Good): No ghost image caused by the transfer memory was observed at all.
B (Good): The ghost image caused by the transfer memory was observed, but only to the extent that its outline was indistinct.
C (Poor): The ghost image caused by the transfer memory was clearly visible.

The transfer resistance was judged as pass if the surface potential after the transfer was good and the image evaluation was good; otherwise, it was judged as fail. The judgment results are shown in Tables 2A-2B.

TABLE 2A

| | | Base treatment conditions | | | | |
|---|---|---|---|---|---|---|
| | | Alkali ionized | | | Pure water | |
| | | water treatment | | | treatment | |
| | Photo- | | Temperature | Time | Temperature | Time |
| | conductor | pH | (°C) | (sec) | (°C) | (sec) |
| Example 1 | A-1 | 10.0 | 35 | 35 | 60 | 30 |
| Example 2 | A-2 | 10.0 | 45 | 35 | 60 | 30 |
| Example 3 | A-3 | 10.0 | 55 | 35 | 60 | 30 |
| Example 4 | A-4 | 11.5 | 35 | 35 | 60 | 30 |
| Example 5 | A-5 | 11.5 | 45 | 35 | 60 | 30 |
| Example 6 | A-6 | 11.5 | 55 | 35 | 60 | 30 |
| Example 7 | A-7 | 10.0 | 35 | 70 | 60 | 30 |
| Example 8 | A-8 | 11.5 | 35 | 70 | 60 | 30 |
| Example 9 | A-9 | 10.0 | 35 | 35 | 60 | 50 |
| Example 10 | A-10 | 11.5 | 35 | 35 | 80 | 50 |
| Example 11 | A-11 | 10.0 | 35 | 35 | 20 | 30 |
| Comparative | B-1 | 10.0 | 30 | 35 | 60 | 30 |
| Example 1 | | | | | | |
| Comparative | B-2 | 11.5 | 20 | 35 | 60 | 30 |
| Example 2 | | | | | | |
| Comparative | B-3 | 9.0 | 35 | 35 | 60 | 30 |
| Example 3 | | | | | | |
| Comparative | B-4 | 11.5 | 35 | 25 | 60 | 30 |
| Example 4 | | | | | | |

| | | | |
|---|---|---|---|
| Comparative | B-5 | 60 | 30 |
| Example 5 | | | |

TABLE 2B

| | Evaluation item | | |
|---|---|---|---|
| | Surface | | |
| | potential | | |
| | after | Ghost | |
| | transfer | image | |
| | (V) | evaluation | Judgment |
| Example 1 | 54 | B | Pass |
| Example 2 | 50 | A | Pass |
| Example 3 | 42 | A | Pass |
| Example 4 | 56 | A | Pass |
| Example 5 | 53 | A | Pass |
| Example 6 | 46 | A | Pass |
| Example 7 | 55 | A | Pass |
| Example 8 | 53 | A | Pass |
| Example 9 | 55 | B | Pass |
| Example 10 | 51 | A | Pass |
| Example 11 | 60 | B | Pass |
| Comparative | 67 | C | Fail |
| Example 1 | | | |
| Comparative | 70 | C | Fail |
| Example 2 | | | |
| Comparative | 68 | C | Fail |
| Example 3 | | | |
| Comparative | 67 | C | Fail |
| Example 4 | | | |
| Comparative | 81 | C | Fail |
| Example 5 | | | |

As shown in Tables 2A-2B, the temperature of the alkaline ionized water used in the treatment of the conductive bases of the photoreceptors (B-1) and (B-2) was less than 35 °C. Consequently, the transfer resistance of the photoreceptors (B-1) and (B-2) failed.

As shown in Tables 2A-2B, the pH of the alkaline ionized water used in the treatment of the conductive base for the photoreceptor (B-3) was less than 10.0. Consequently, the transfer resistance of the photoreceptor (B-3) failed.

As shown in Tables 2A-2B, the immersion time in the alkaline ionized water during the treatment of the conductive base for the photoreceptor (B-4) was less than 35 seconds. Consequently, the transfer resistance of the photoreceptor (B-4) failed.

As shown in Tables 2A-2B, the conductive base for the photoreceptor (B-5) was not treated with the alkaline ionized water. Consequently, the transfer resistance of photoreceptor (B-5) failed.

On the other hand, as shown in Tables 2A-2B, the photosensitive bodies (A-1) to (A-11) had the following configurations. Specifically, the treatment of the conductive base included a step using the alkaline ionized water, with an immersion time of 35 seconds or more, a pH of 10.0 or more for the alkaline ionized water used, and a temperature of 35 °C or more for the alkaline ionized water. Consequently, as shown in Tables 2A-2B, the transfer resistance of the photoreceptors (A-1) to (A-11) passed.

Specifically, comparing Example 4 with Comparative Example 4, even when the alkaline ionized water had a pH of 10.0 or more and a temperature of 35 °C or more, if the immersion time was less than 35 seconds, the transfer resistance failed. Furthermore, comparing Example 1 with Comparative Example 1, or Example 4 with Comparative Example 2, even when the alkaline ionized water had a pH of 10.0 or more and the immersion time was 35 seconds or more, if the temperature was less than 35 °C, the transfer resistance failed. Furthermore, comparing Example 1 with Comparative Example 3, even when the alkaline ionized water temperature is 35 °C or more and the immersion time is 35 seconds or more, if the alkaline ionized water pH is less than 10.0, the transfer resistance failed. That is, it was found that the photoreceptor with good transfer resistance can be obtained only when using the treatment method for the conductive base according to the present disclosure.

Those skilled in the art will understand that various modifications, combinations, subcombinations, and alterations may be made within the scope of the appended claims or their equivalents, depending on design requirements and other factors.

What is claimed is:

1. A method for manufacturing a negatively charged electrophotographic photoreceptor including a conductive base, and a photosensitive layer held on the conductive base, comprising:
immersing the conductive base containing aluminum or an aluminum alloy in alkaline ionized water having a pH of 10.0 or more and a temperature of 35 °C or more for 35 seconds or more.

2. The method for manufacturing the electrophotographic photoreceptor according to claim 1, wherein
the conductive base immersed in the alkaline ionized water is immersed in pure water at 60 °C or more.

3. The method for manufacturing the electrophotographic photoreceptor according to claim 1, wherein
the conductive base immersed in the alkaline ionized water is immersed in pure water at 60 °C or more for 30 seconds or more.
